(19) United States
(12) Patent Application Publication
(10) Pub. No.: US 2025/0166149 A1
(43) Pub. Date: May 22, 2025

(54) A METHOD, MEDIUM, AND DEVICE FOR ESTIMATING THE LENGTH OF PIPELINE CRACKS BASED ON VIDEO IMAGES

(71) Applicant: ZHEJIANG UNIVERSITY, Hangzhou (CN)

(72) Inventors: Yiyi Ma, Hangzhou (CN); Chenhao Yang, Hangzhou (CN); Tuqiao Zhang, Hangzhou (CN); Zhiwei Zhu, Hangzhou (CN); Feifei Zheng, Hangzhou (CN)

(21) Appl. No.: 18/290,314

(22) PCT Filed: Sep. 14, 2023
(86) PCT No.: PCT/CN2023/118805

§ 371 Date: Feb. 5, 2025

(30) Foreign Application Priority Data
Sep. 11, 2023 (CN) 2023111691500

(51) Int. Cl. G06T 7/00; G06T 7/11; G06T 7/174; G06T 7/62; G06T 7/73; G06V 10/26; G06V 10/52; G06V 10/77; G06V 10/82; G06V 20/10

(52) U.S. Cl. CPC G06T 7/0002; G06T 7/11; G06T 7/174; G06T 7/62; G06T 7/74; G06V 10/273; G06V 10/52; G06V 10/7715; G06V 10/82; G06V 20/176; G06T 2207/30184; G06T 2207/30204

(57) ABSTRACT

The present invention relates to the field of image processing technology, specifically to a method, medium, and device for estimating the length of pipeline cracks based on video images. The method comprises the steps of A, extracting images with cracks from acquired pipeline videos, and making them into a dataset; B, establishing a segmentation model to segment the images in the obtained dataset to obtain crack images containing only cracks; C, marking the crack image to obtain the center coordinate of the crack images; D, obtaining the coordinate of all the pixels on the crack from the crack image, and calculating the length of the crack based on the obtained coordinates of the center and all pixels on the crack. This invention can overcome the challenges of quantifying crack length caused by the shooting angle, enabling the measurement of crack length on the inner wall of the pipeline using only pipeline inspection images. This significantly improves the accuracy of crack length quantification and provides a reference basis for further repair of drainage pipelines.

### CROSS REFERENCE TO RELATED APPLICATIONS

This application claims priority to PCT International Application No. PCT/CN2023/118805, filed on Sep. 14, 2023, and Chinese Patent Application No. 2023111691500, filed on Sep. 11, 2023; the disclosures of which are incorporated herein by reference in their entireties.

### TECHNICAL FIELD

The present invention relates to the field of image processing technology, and specifically relates to a method for estimating the length of pipeline cracks based on images.

### BACKGROUND ART

Urban drainage pipelines are an important part of normal urban operation, not only undertaking the transportation of urban residents' and industrial production wastewater, but also undertaking the collection and discharge of urban rainwater. Due to the long construction time of most of the drainage pipe network, complex underground environment, and improper operation and maintenance, defects such as pipeline crack are increasingly prominent. These defects will greatly affect the drainage capacity of the drainage pipe network, exacerbate sewage overflow, water pollution, urban waterlogging and other disaster risks, eventually result in economic losses to the city, and even loss of residents' lives and property.

CCTV (Closed-Circuit Television) is one of the commonly used means for detecting defects in drainage pipelines. However, for a large amount of CCTV data, detection personnel need to spend a lot of time and effort to find defects and evaluate grades. In addition, the relevant definitions in the current specifications are relatively broad. Due to the different experiences of detection personnel, the same defect may also be classified into different grades. Therefore, in order to reduce the labor burden of detection personnel and ensure the objectivity of defect assessment, algorithms based on computer vision techniques have been developed.

Computer vision technology is a comprehensive discipline including computer science, image processing, pattern recognition, etc. It is used to simulate human visual functions, observe the state of objects, and extract key information. Deep learning based on computer vision technology has begun to be widely used in the processing of drainage pipeline CCTV data, such as: target detection technology and semantic segmentation technology. Target detection technology has been applied earlier in pipeline defect detection, such as: YOLO (You Only Look Once) series algorithms, R-CNN (Region Convolutional Neural Networks), etc.

In CCTV images, it can annotate the specific location and specific category of pipeline defects with anchor boxes, which can greatly reduce the workload of detection personnel. However, target detection technologies using anchor boxes cannot annotate the specific morphology of pipeline defects.

Semantic segmentation technologies like U-net and DeepLab series algorithms, have been applied in pipeline defect detection. Semantic segmentation technology can segment defects in CCTV data to obtain the specific morphology of the defects, thereby further assisting detection personnel in evaluating the level of pipeline defects. However, this method still cannot fully achieve automated pipeline defect recognition. The process still requires detection personnel to manually evaluate defects. In addition, due to the complex internal environment of drainage pipelines and poor shooting conditions, there are still problems in the application of computer vision technology in pipeline detection.

### SUMMARY OF THE INVENTION

To address the above problems existing in the prior art, the present invention provides an image-based pipeline crack length estimation method that can overcome the obstacle of shooting angle to crack length quantification, so as to achieve the effect of measuring the crack length on the inner wall of the pipeline only by pipeline detection images, and provide a reference for further repairs of drainage pipelines.

In a first aspect, an embodiment of the present application provides a video-image-based pipeline crack length quantification method, including the steps of
A. Extracting images with cracks from acquired pipeline video and making them into a dataset;
B. Establishing a segmentation model to segment the images in the obtained dataset, in order to obtain image containing cracks;
C. Marking the crack image to obtain the center coordinate position of the crack image;
D. Obtaining the coordinate of all pixels on the crack from the crack image, and calculating the length of the crack on the pipeline based on the obtained coordinate of the center and all pixels on the crack.

In an alternative solution of the first aspect, step C is specifically as follows: judging the crack image to determine if there is a pipeline joint; if there is a pipeline joint, marking the center coordinate of the pipeline joint, while if not, marking the center coordinate of the crack image.

In another alternative solution of the first aspect, before executing step D, preprocessing is performed to remove abnormal pixels from the crack image.

In another alternative solution of the first aspect, before executing step D, preprocessing is performed, specifically, traversing the pixels of the crack image following the principle: if a pixel has at least three non-zero pixels on its left and right sides, bottom side, and the left and right sides of its bottom side, the value of this pixel is set to zero; if all the pixels on the left and right sides of a pixel are zeros, the value of this pixel is set to zero as well.

In another alternative solution of the first aspect, in step D, the calculation formula of the crack length is:

L=αΣLᵢ

Where, L represents the crack length, Lᵢ represents the actual length corresponding to pixel i, and α represents a correction coefficient. Since the camera shooting angle and image resolution will affect the quantification accuracy of cracks, the more inclined the shooting angle and the lower the image resolution, the lower the quantification accuracy of cracks. Therefore, a correction coefficient needs to be added as an adjustment.

In another alternative solution of the first aspect, in step D, the specific calculation formula of the crack length is:

$$L = α \sum {L}_{i} = α \sum \frac{{C}_{s}}{{C}_{i}}$$

where Cᵢ represents the calculated pipeline circumference, Cₛ represents the actual pipeline circumference.

In another alternative solution of the first aspect, the calculation formulas of the calculated pipeline circumference and the actual pipeline circumference are:

$$\{ \begin{matrix}{C}_{i} = 2 π \sqrt{{( {y}_{i} - {y}_{c} )}^{2} + {( {x}_{i} - {x}_{c} )}^{2}} \\ {C}_{s} = 2 π {R}_{s}\end{matrix}$$

Where, Rₛ represents the actual pipeline radius, x_{c} represents the horizontal coordinate of the center coordinate position, y_{c} represents the vertical coordinate of the center coordinate position, xᵢ represents the horizontal coordinate of pixel i, and yᵢ represents the vertical coordinate of pixel i.

In another alternative solution of the first aspect, in step B, the established segmentation model includes an encoder and a decoder connected in sequence. The encoder includes feature extraction layers and pooling layers connected in sequence for extracting features at different scales.

In a second aspect, an embodiment of the present application provides a computer-readable storage medium storing a computer instructions for executing a method provided in the first aspect or any implementation manner of the first aspect for estimating the length of pipeline cracks based on video images.

In a third aspect, an embodiment of the present application provides an electronic device, comprising a memory and a communication connection between the memory and the processer. The memory stores computer instructions, and the processor executes a video-image-based pipeline crack length estimation method provided in the first aspect or any implementation manner of the first aspect by executing the computer instructions.

The beneficial technical effects of the present invention include:
1. The present invention proposes an image-based pipeline crack length estimation method, which breaks through the bottleneck of computer vision technology in municipal pipeline defect recognition, and uses pipeline detection images, combined with the DeepLab V3+ semantic segmentation model and crack length estimation method, to achieve quantification of the crack length on the inner wall of the pipeline only by pipeline detection images.
2. The DeepLab V3+ semantic segmentation model is used. Compared with the FCN model, its crack segmentation accuracy is higher, which can significantly improve the accuracy of crack length quantification.

### BRIEF DESCRIPTION OF THE DRAWINGS

The technical solutions of the embodiments of the present invention or the prior art are clearly and completely described below with reference to the accompanying drawings needed for the embodiments or the prior art description. Apparently, the accompanying drawings described below are only some embodiments of the present invention. Ordinary technicians in the art can also obtain other accompanying drawings based on these accompanying drawings without creative efforts.

FIG. 1 is a flowchart of an image-based pipeline crack length estimation method according to the present invention;

FIG. 2 is a block diagram of the network structure of the semantic segmentation model of the present invention;

FIG. 3 is a schematic diagram of preprocessing the crack image in Embodiment 1 of the present invention;

FIG. 4 is a schematic diagram of calculating the pipeline circumference based on pixel i in Embodiment 1 of the present invention;

FIG. 5 is a performance diagram of three different segmentation models in Embodiment 1 of the present invention.

### EMBODIMENTS OF THE PRESENT DISCLOSURE

The technical solutions in the embodiments of the present application will be clearly and completely described below with reference to the accompanying drawings in the embodiments of the present application.

In the following description, the terms “first”, “second”, etc. are only used for description purposes and cannot be understood as indicating or implying relative importance. The following description provides a number of examples of the present application, and various examples may be appropriately combined or recombined between different examples. Therefore, the present application may also be considered to contain all possible combinations including the same and/or different examples described below, although such examples may not be explicitly described below.

### Embodiment 1

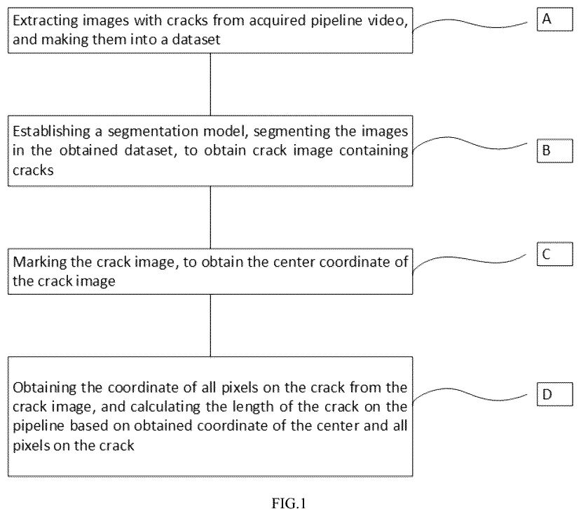

Referring to FIG. 1, a video image-based pipeline crack length estimation method includes the steps of:

Step A, obtaining a dataset from CCTV videos, extracting images of cracked pipelines from the CCTV videos, and making them into the dataset.

Step B, establishing a segmentation model to segment the images in the obtained dataset, in order to obtain crack images containing cracks.

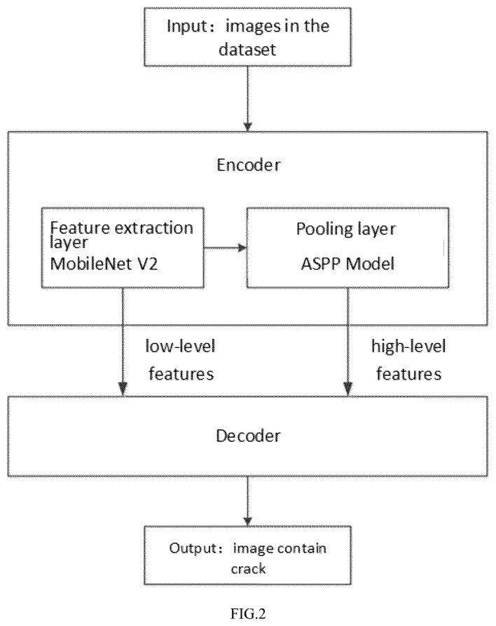

Referring to FIG. 2, further, the segmentation model: DeepLab V3+ semantic segmentation model with MobileNet V2 as the backbone network. The segmentation model includes an encoder and a decoder connected in sequence. The encoder includes feature extraction layers and pooling layers connected in sequence. The feature extraction layer is MobileNet V2, which is used to extract low-level features. The pooling layer is the ASPP Model, which is used to extract high-level features. The images in the dataset are input into the segmentation model, and after being processed by the decoder and encoder connected in sequence, only the crack images containing cracks are output.

Specifically, the feature extraction layer MobileNet V2 includes two residual structures connected in sequence. The first residual structure and the second residual structure each includes three convolutional blocks. In the first residual structure, the convolution kernel of convolutional block 1 is 1*1 with a stride of 1, that of convolutional block 2 is 3*3 with a stride of 1, and that of convolutional block 3 is 1*1 with a stride of 1. In the second residual structure, that of convolutional block 1 is 1*1 with a stride of 1, that of convolutional block 2 is 3*3 with a stride of 1, and that of convolutional block 3 is 1*1 with a stride of 1. Specifically, convolutional blocks 1 and convolutional blocks 2 in the first residual structure and the second residual structure each include convolutional layers, batch normalization layers, and activation function layers connected in sequence. Convolutional blocks 3 in the first and second residual structures each includes convolutional layers and batch normalization layers connected in sequence. The output of the first residual structure is concatenated with the input image of the feature extraction layer, and together serve as the input for the second residual structure.

The ASPP structure is added to the segmentation model, including convolutional layers with multiple convolution kernels of different sizes and maximum pooling layers connected in sequence, which can further enhance the feature extraction ability of the model. The purpose is to expand the receptive field to enable the segmentation model to understand broader context information, which is used to solve the problem of loss of spatial information.

Specifically, the pooling layer of ASPP includes five convolutional blocks of different sizes arranged in parallel, each including convolutional layers, batch normalization layers, and activation function layers connected in sequence. The convolution kernel of the first convolutional block is 1*1 with a stride of 1 and a residue of 1. The convolution kernel of the second convolutional block is 3*3 with a stride of 1 and a residue of 12. The convolution kernel of the third convolutional block is 3*3 with a stride of 1, a padding of 24, and a residue of 24. The convolution kernel of the fourth convolutional block is 3*3 with a stride of 1, a padding of 36, and a residue of 36. The convolution kernel of the fifth convolutional block is 3*3 with a stride of 1. Specifically, the network structure of the fifth convolutional block contains an adaptive average pooling layer, a convolutional layer, a batch normalization layer, an activation function layer, and a bilinear interpolation layer connected in sequence. The convolution results of the five convolutional blocks of different sizes are concatenated in the channel dimension, and then go through another convolutional block with a convolution kernel of 1*1 and a stride of 1, followed by regularization to extract high-level features.

The network structure of the decoder includes five convolutional blocks of different sizes connected in sequence, each including convolutional layers, batch normalization layers, and activation function layers connected in sequence. The convolution kernel of convolutional block 1 is 1*1 with a stride of 1 and padding of 0. The convolution kernel of convolutional block 2 is 3*3 with a stride of 1 and padding of 1. The convolution kernel of convolutional block 3 is 3*3 with a stride of 1 and padding of 1.

The low-level features extracted by the feature extraction layer MobileNet V2 are input into the decoder. After convolutional block 1, they are concatenated with the high-level features extracted by the pooling layer ASPP Model, then go through convolutional blocks 2 and 3, and finally go through the bilinear interpolation layer to obtain the output image, which is the crack image.

The established segmentation model is trained. 133 images of drainage pipelines in the CCTV inspection videos are selected. With the image been flipped, panned, cropped, etc., the amount of training data was expanded to 730. The resolution of the images in the expanded training dataset is 1920*1080. The dataset is divided into a training set and a validation set at a ratio of 9:1. The number of images in the training set is 657, and that in the validation set is 73. Manual annotation is performed on the validation set images to generate annotation files in Json format, which is a lightweight data exchange format.

Cross entropy loss is introduced as the loss function. During training, the learning rate is set to 0.0001 to stabilize the deep structure of the segmentation model. Batch size is set to 4, i.e., processing 4 images per batch, until the loss function converges to the pre-set value, to obtain a well-trained segmentation model.

Step C, marking the crack image using the Hough circle detection method to obtain the center coordinate position of the pipeline joint.

Further, step C is specifically judging whether there is a pipeline joint in the crack image. If there is a pipeline joint, mark the center coordinate of the pipeline joint. If there is no pipeline joint, mark the center coordinate of the crack image.

Referring to FIG. 3, before executing step D, preprocessing is performed, specifically, traversing the pixels of the crack image. If there are two or more non-zero pixels on the side and below this pixel, or if all the pixels on the side are zero, the value of this pixel will be set to zero.

Specifically, if pixel A is a non-zero pixel in a crack image, and there are at least three non-zero pixels located on its the left and right sides, the bottom side, and the left and right sides of its bottom side, that is, there are more than two non-zero pixels in pixels a1-a5, then the value of pixel A is set to 0. Accordingly, the width of the annotation line is only one pixel in size.

Step D, based on the crack image, obtaining the coordinates of all pixels i on the crack, and calculating the length of the crack on the pipeline according to the obtained center coordinate position and the coordinate positions of all pixels i on the crack.

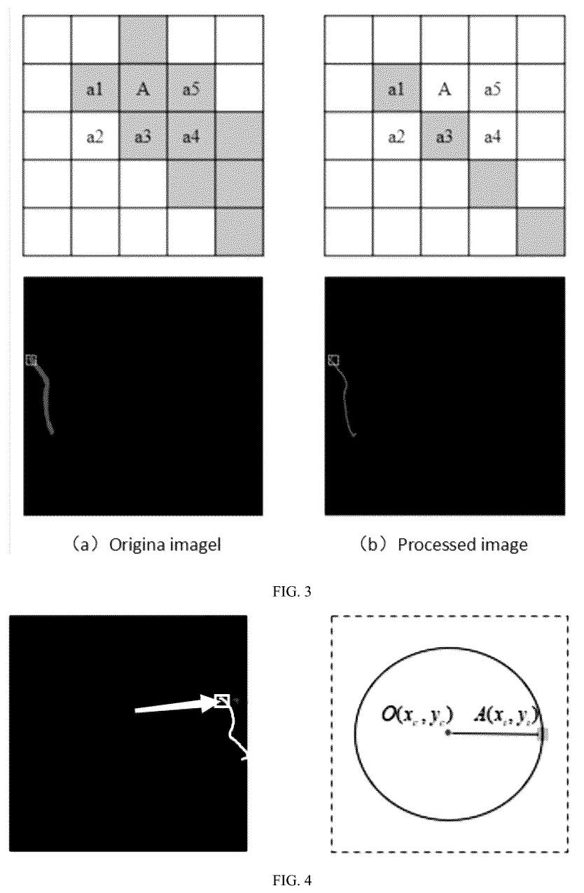

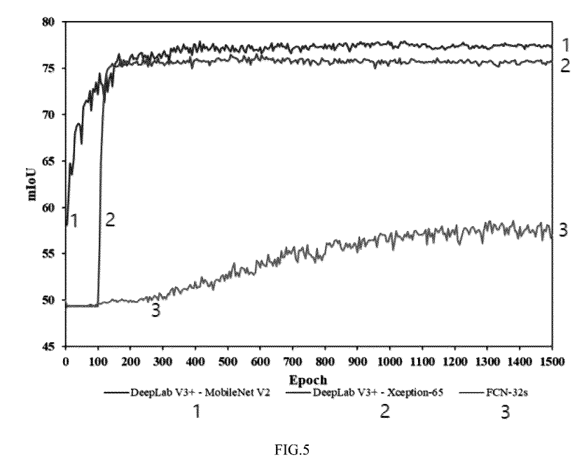

Referring to FIG. 4, considering the coordinates of pixel i (xᵢ, yᵢ), and the coordinates of center O (x_{c}, y_{c}), a circle is drawn using the distance between the point i and the center O as the radius to construct a circle as the pipeline, calculating the circumference of the circle, and comparing it with the actual pipeline circumference, the calculation formula is:

$$\{ \begin{matrix}{C}_{i} = 2 π \sqrt{{( {y}_{i} - {y}_{c} )}^{2} + {( {x}_{i} - {x}_{c} )}^{2}} \\ {C}_{s} = 2 π {R}_{s}\end{matrix}$$

where Cᵢ represents the calculated pipeline circumference, x_{c} represents the horizontal coordinate of the center O, y_{c} represents the vertical coordinate of the center O, xᵢ represents the horizontal coordinate of pixel i, yᵢ represents the vertical coordinate of pixel i, Cₛ represents the actual pipeline circumference, and Rₛ represents the actual pipeline radius.

By scaling with the actual pipeline circumference, the actual length each pixel point i represents can be calculated as:

$${L}_{i} = \frac{{C}_{s}}{{C}_{i}} = \frac{2 π {R}_{s}}{2 π \sqrt{{( {y}_{i} - {y}_{c} )}^{2} + {( {x}_{i} - {x}_{c} )}^{2}}} = \frac{{R}_{s}}{\sqrt{{( {y}_{i} - {y}_{c} )}^{2} + {( {x}_{i} - {x}_{c} )}^{2}}}$$

By calculating the actual length corresponding to each pixel i on the crack and summing them up, obtain the actual length of the crack, the calculation formula is:

$$L = \sum {L}_{i} = \sum \frac{{R}_{s}}{\sqrt{{( {y}_{i} - {y}_{c} )}^{2} + {( {x}_{i} - {x}_{c} )}^{2}}}$$

Since the camera shooting angle and image resolution will affect the accuracy of pipeline crack quantification, the more inclined the shooting angle, the lower the image resolution, and the lower the quantification accuracy of cracks. Therefore, the present invention introduces a correction coefficient α as an adjustment to obtain the actual length of the corrected crack. The calculation formula is:

$$L = α \sum {L}_{i} = α \sum \frac{{R}_{s}}{\sqrt{{( {y}_{i} - {y}_{c} )}^{2} + {( {x}_{i} - {x}_{c} )}^{2}}}$$

The present invention combines the DeepLab V3+ semantic segmentation model and municipal drainage pipeline CCTV images to overcome the obstacle of shooting angle to crack length quantification, thereby achieving the function of measuring the crack length on the inner wall of the pipeline only by CCTV images.

Verification experiments were carried out with 50 images extracted from real CCTV video databases. Among them, 25 images have a resolution of 480*260, and the correction coefficient α is set to 2.0. The other 25 images have a resolution of 1920*1080, and the correction coefficient α is set to 1.0.

Referring to FIG. 5, construct DeepLab V3+ network and FCN-32s network with Xception-65 as the backbone network, and compare it with the segmentation model constructed in the present invention on a host equipped with 12th Gen Intel® Core™ i7-12700KF (20 CPUs) and NVIDIA GeForce RTX 3080 with 10 G memory.

The calculation results using the method of the present invention are compared with the real data of pipeline cracks obtained on site to verify the feasibility of the method of the present invention. Since the length information of the cracks in these real images is unknown, according to the national and local specifications for grading drainage pipe cracks, the damage grade is determined according to the pipeline crack length estimated by the method of the present invention.

The calculation results of the present invention method are shown in the table below:

TABLE
Schematic Table

| Image | Resolution/ | | Mobile | Xception- | FCN- | |
|---|---|---|---|---|---|---|
| No. | Pixels | α | Net V2 | 65 | 32s | Damage grade |
| 1 | 480*260 | 2.0 | 309.02 | 283.38 | 159.35 | Grade 1, 0-250 |
| | | | | | | mm |
| 2 | 480*260 | 2.0 | 267.32 | 489.44 | 204.51 | Grade 2, 250-500 |
| | | | | | | mm |
| 3 | 480*260 | 2.0 | 552.10 | 663.55 | 490.77 | Grade 2, 250-500 |
| | | | | | | mm |
| 4 | 480*260 | 2.0 | 647.30 | 710.24 | 460.96 | Grade 3, 500-750 |
| | | | | | | mm |
| 5 | 480*260 | 2.0 | 134.76 | 140.96 | 78.86 | Grade 2, 250-500 |
| | | | | | | mm |
| 6 | 480*260 | 2.0 | 430.52 | 665.11 | 211.85 | Grade 2, 250-500 |
| | | | | | | mm |
| 7 | 480*260 | 2.0 | 612.82 | 781.32 | 555.68 | Grade 2, 250-500 |
| | | | | | | mm |
| 8 | 480*260 | 2.0 | 811.10 | 877.42 | 650.22 | Grade 3, 500-750 |
| | | | | | | mm |
| 9 | 480*260 | 2.0 | 850.09 | 901.10 | 688.82 | Grade 3, 500-750 |
| | | | | | | mm |
| 10 | 480*260 | 2.0 | 317.86 | 299.18 | 198.48 | Grade 2, 250-500 |
| | | | | | | mm |
| 11 | 480*260 | 2.0 | 304.52 | 295.88 | 159.68 | Grade 2, 250-500 |
| | | | | | | mm |
| 12 | 480*260 | 2.0 | 270.52 | 289.58 | 123.27 | Grade 3, 500-750 |
| | | | | | | mm |
| 13 | 480*260 | 2.0 | 890.10 | 920.59 | 531.13 | Grade 3, 500-750 |
| | | | | | | mm |
| 14 | 480*260 | 2.0 | 350.78 | 423.50 | 378.24 | Grade 3, 500-750 |
| | | | | | | mm |
| 15 | 480*260 | 2.0 | 475.56 | 632.12 | 447.18 | Grade 3, 500-750 |
| | | | | | | mm |
| 16 | 480*260 | 2.0 | 265.52 | 261.48 | 179.95 | Grade 1, 0-250 |
| | | | | | | mm |
| 17 | 480*260 | 2.0 | 339.96 | 265.86 | 144.20 | Grade 2, 250-500 |
| | | | | | | mm |
| 18 | 480*260 | 2.0 | 615.50 | 514.46 | 381.76 | Grade 3, 500-750 |
| | | | | | | mm |
| 19 | 480*260 | 2.0 | 690.15 | 725.55 | 509.79 | Grade 3, 500-750 |
| | | | | | | mm |
| 20 | 480*260 | 2.0 | 730.13 | 713.08 | 226.54 | Grade 3, 500-750 |
| | | | | | | mm |
| 21 | 480*260 | 2.0 | 798.76 | 696.54 | 281.30 | Grade 3, 500-750 |
| | | | | | | mm |
| 22 | 480*260 | 2.0 | 368.66 | 520.54 | 109.85 | Grade 2, 250-500 |
| | | | | | | mm |
| 23 | 480*260 | 2.0 | 572.30 | 596.00 | 339.12 | Grade 3, 500-750 |
| | | | | | | mm |
| 24 | 480*260 | 2.0 | 113.44 | 140.81 | 89.27 | Grade 1, 0-250 |
| | | | | | | mm |
| 25 | 480*260 | 2.0 | 557.93 | 501.77 | 323.18 | Grade 2, 250-500 |
| | | | | | | mm |
| 26 | 1920*1080 | 1.0 | 577.06 | 564.52 | 459.58 | Grade 3, 500-750 |
| | | | | | | mm |
| 27 | 1920*1080 | 1.0 | 612.60 | 593.93 | 492.12 | Grade 2, 250-500 |
| | | | | | | mm |
| 28 | 1920*1080 | 1.0 | 143.41 | 152.60 | 80.40 | Grade 1, 0-250 |
| | | | | | | mm |
| 29 | 1920*1080 | 1.0 | 217.46 | 209.80 | 119.98 | Grade 2, 250-500 |
| | | | | | | mm |
| 30 | 1920*1080 | 1.0 | 516.99 | 488.34 | 433.75 | Grade 3, 500-750 |
| | | | | | | mm |
| 31 | 1920*1080 | 1.0 | 291.15 | 309.30 | 220.77 | Grade 1, 0-250 |
| | | | | | | mm |
| 32 | 1920*1080 | 1.0 | 117.32 | 121.71 | 68.20 | Grade 1, 0-250 |
| | | | | | | mm |
| 33 | 1920*1080 | 1.0 | 351.38 | 381.95 | 235.97 | Grade 2, 250-500 |
| | | | | | | mm |
| 34 | 1920*1080 | 1.0 | 456.41 | 442.07 | 387.13 | Grade 3, 500-750 |
| | | | | | | mm |
| 35 | 1920*1080 | 1.0 | 269.96 | 245.91 | 174.93 | Grade 2, 250-500 |
| | | | | | | mm |
| 36 | 1920*1080 | 1.0 | 812.67 | 829.18 | 790.32 | Grade 3, 500-750 |
| | | | | | | mm |
| 37 | 1920*1080 | 1.0 | 412.52 | 431.87 | 352.99 | Grade 2, 250-500 |
| | | | | | | mm |
| 38 | 1920*1080 | 1.0 | 780.40 | 767.94 | 761.12 | Grade 3, 500-750 |
| | | | | | | mm |
| 39 | 1920*1080 | 1.0 | 701.94 | 687.61 | 544.09 | Grade 3, 500-750 |
| | | | | | | mm |
| 40 | 1920*1080 | 1.0 | 578.13 | 596.64 | 437.11 | Grade 3, 500-750 |
| | | | | | | mm |
| 41 | 1920*1080 | 1.0 | 247.90 | 255.14 | 193.06 | Grade 2, 250-500 |
| | | | | | | mm |
| 42 | 1920*1080 | 1.0 | 567.09 | 555.24 | 479.74 | Grade 3, 500-750 |
| | | | | | | mm |
| 43 | 1920*1080 | 1.0 | 310.69 | 329.20 | 231.92 | Grade 1, 0-250 |
| | | | | | | mm |
| 44 | 1920*1080 | 1.0 | 422.03 | 445.80 | 410.52 | Grade 3, 500-750 |
| | | | | | | mm |
| 45 | 1920*1080 | 1.0 | 179.82 | 166.19 | 42.85 | Grade 2, 250-500 |
| | | | | | | mm |
| 46 | 1920*1080 | 1.0 | 588.54 | 561.25 | 391.27 | Grade 3, 500-750 |
| | | | | | | mm |
| 47 | 1920*1080 | 1.0 | 441.48 | 419.20 | 303.29 | Grade 2, 250-500 |
| | | | | | | mm |
| 48 | 1920*1080 | 1.0 | 233.16 | 234.69 | 212.17 | Grade 1, 0-250 |
| | | | | | | mm |
| 49 | 1920*1080 | 1.0 | 307.60 | 325.65 | 177.02 | Grade 2, 250-500 |
| | | | | | | mm |
| 50 | 1920*1080 | 1.0 | 588.35 | 608.05 | 311.40 | Grade 3, 500-750 |
| | | | | | | mm |

| | | | | |
|---|---|---|---|---|
| Accuracy | 27/50 | 26/50 | 18/50 | / |

Experimental Results Analysis: Compared with the DeepLab V3+ model with Xception-65 backbone and the FCN model, the DeepLab V3+ model with MobileNet V2 backbone has a higher accuracy. The better the performance of the semantic segmentation model, the higher the accuracy of crack length quantification. The crack quantification method of the DeepLab V3+ model with MobileNet V2 as the backbone network can accurately quantify 27 cracks in 50 cases, with high accuracy and high precision.

The crack estimation method proposed in this invention is based on the principle of scaling each pixel to obtain the actual lengths they represent, in order to calculate the total length of the crack. Since the pixel size is small, the length, the width and diagonal size of the pixel will be considered consistent. Therefore, the lengths of inclined cracks, horizontal cracks and vertical cracks can all be calculated 1 using this method.

The method proposed in this invention is named DL-CLQ, i.e., the DeepLab-Crack Length Quantification method. The DL-CLQ method proposed in this invention has great potential to be applied for the detection and quantification of other defects, and can be further reasonably developed and applied to the identification of other defects.

Embodiment 2: A computer-readable storage medium that stores computer instructions, wherein the computer instructions are used to enable a computer to execute a method for estimating the length of pipeline cracks based on video images, as proposed in Embodiment 1.

Embodiment 3: An electronic device that includes a memory and a processor, wherein the memory and the processor are interconnected for communication. The memory stores computer instructions, and the processor executes the computer instructions to perform a method for estimating the length of pipeline cracks based on video images, as proposed in Embodiment 1. The embodiments described above are only preferred embodiments of the present invention and do not limit the scope of the present invention. Without departing from the spirit of the design of the present invention, various modifications and improvements made by those skilled in the art to the technical solutions of the present invention shall fall within the protection scope of the present invention.

What is claimed is:

1. A method for estimating the length of pipeline cracks based on images, comprising:
A. Extracting images with cracks from acquired pipeline video, and making them into a dataset;
B. Establishing a segmentation model, segmenting the images in the obtained dataset, to obtain crack image containing cracks;
C. Marking the crack image, to obtain the center coordinate of the crack image;
D. Obtaining the coordinate of all pixels on the crack from the crack image, and calculating the length of the crack on the pipeline based on obtained coordinate of the center and all pixels on the crack.

2. The method for estimating the length of pipeline cracks based on images according to claim 1, wherein the step C is specifically as follows: judging the crack image to determine if there is a pipeline joint; if there is a pipeline joint, marking the center coordinate of the pipeline joint, while if not, marking the center coordinate of the crack image.

3. The method for estimating the length of pipeline cracks based on images according to claim 1, wherein before executing step D, preprocessing is performed to remove abnormal pixels from the crack image.

4. The method for estimating the length of pipeline cracks based on images according to claim 3, wherein before executing step D, preprocessing is performed, specifically, traverse the pixels of the crack image following the principle: if a pixel has at least three non-zero pixels on its left and right sides, bottom side, and the left and right sides of its bottom side, the value of this pixel is set to zero; if all the pixels on the left and right sides of a pixel are zeros, the value of this pixel is set to zero as well.

5. The method for estimating the length of pipeline cracks based on images according to claim 1, wherein in step D, the calculation formula of the crack length is:
L=αΣLᵢ
where represents the crack length, represents the actual length corresponding to pixel i, and represents a correction coefficient.

6. The method for estimating the length of pipeline cracks based on images according to claim 5, wherein in step D, the specific calculation formula of the crack length is:
$$L = α \sum {L}_{i} = α \sum \frac{{C}_{s}}{{C}_{i}}$$
where represents the calculated pipeline circumference, and represents the actual pipeline circumference.

7. The method for estimating the length of pipeline cracks based on images according to claim 6, wherein the calculation formulas of the calculated pipeline circumference and the actual pipeline circumference are:
$$\{ \begin{matrix}{C}_{i} = 2 π \sqrt{{( {y}_{i} - {y}_{c} )}^{2} + {( {x}_{i} - {x}_{c} )}^{2}} \\ {C}_{s} = 2 π {R}_{s}\end{matrix}$$
where represents the actual pipeline radius, represents the horizontal coordinate of the center coordinate position, represents the vertical coordinate of the center coordinate position, represents the horizontal coordinate of pixel i, and represents the vertical coordinate of pixel i.

8. The method for estimating the length of pipeline cracks based on images according to claim 1, wherein in step B, the established segmentation model includes an encoder and a decoder connected in sequence. The encoder includes feature extraction layers and pooling layers connected in sequence for extracting features at different scales.

9. A computer-readable storage medium, wherein the computer-readable storage medium stores computer instructions for executing a method for estimating the length of pipeline cracks based on video images, as claimed in claim 1-8.

10. An electronic device, wherein it comprises a memory and a processor, and a communication connection between the memory and the processor. The memory stores computer instructions, and the processor executes the computer instructions to perform a method for estimating the length of pipeline cracks based on images, as claimed in claim 1-8.
